(19) United States
(12) Patent Application Publication
(10) Pub. No.: US 2025/0282404 A1
(43) Pub. Date: Sep. 11, 2025

(54) METHOD AND SYSTEM FOR MANAGING TRAFFIC OF GUIDED VEHICLES OVER A RAILWAY NETWORK

(71) Applicant: Siemens Mobility SAS, Chatillon (FR)

(72) Inventor: Thomas Casadei, Asnieres-sur-Seine (FR)

(21) Appl. No.: 19/072,032

(22) Filed: Mar. 6, 2025

(30) Foreign Application Priority Data
Mar. 6, 2024 (EP) 24305342.8

(51) Int. Cl. B61L 27/16

(52) U.S. Cl. CPC B61L 27/16

(57) ABSTRACT

A traffic control system and method manage the traffic of guided vehicles over a railway network. The method includes acquiring a timetable for the vehicles, acquiring a map of the network and using the map of the network for dividing/splitting the network into a set of successive track sections delimited by boundary position. A list of the vehicles crossing the boundary position for each boundary position is determined. From the map, the timetable, the boundary positions and the list, a directed graph containing nodes and directed edges is created. Each node represents an itinerary followed by the vehicles, and each directed edge is configured for connecting two of the nodes. The directed graph is an input to an algorithm configured for automatically detecting whether the directed graph contains one or several cycles. If no cycle is detected, then the traffic of the guided vehicles is managed according to the timetable.

### CROSS-REFERENCE TO RELATED APPLICATION

This application claims the priority, under 35 U.S.C. § 119, of European Patent Application EP24305342.8, filed Mar. 6, 2024; the prior application is herewith incorporated by reference in its entirety.

### FIELD AND BACKGROUND OF THE INVENTION

The present invention concerns the management of traffic of guided vehicles over a railway network. By “guided vehicle”, it has to be understood any rail transport means configured for moving on tracks of a railway network, the guided vehicle typically running on at least one rail configured for supporting one or several wheels of the guided vehicle or using at least one rail as guiding means for guiding the guided vehicle along a trajectory defined by the rail. The rail transport means are for instance public transport means like subways, trains or train units, etc., as well as load transporting means such as, for example, freight trains, for which safety is a very important factor.

The traffic of guided vehicles over a railway network is usually managed by traffic control systems. The latter are in charge of the routing of guided vehicles on the railway network. They usually control the traffic based on a timetable that defines a routing plan for the guided vehicles. The timetable enables to determine a scheduling (i.e. an order) of the guided vehicles at any point or at predefined points of the railway network (e.g. at crossing, at a switch, etc.). As long as the guided vehicles are moving according to the planned timetable, things are fine. However, as soon as an issue occurs, e.g. a guided vehicle is delayed, then the timetable might have to be changed and new routing calculated. A change in a timetable is always of major concern, as any error or mistake might have serious consequences on the traffic of guided vehicles. Until now, no traffic control system is able to efficiently and automatically apply changes to a timetable. Usually, they are only able to recalculate a new timetable by applying delays to one or several guided vehicles, so that consistency remains ensured within the new timetable. There is therefore a need for a system and method which could efficiently manage any change in a timetable in a way that ensures an efficient movement of the guided vehicles routed according to the timetable.

### SUMMARY OF THE INVENTION

An objective of the present invention is to propose a method and a system for managing traffic of guided vehicles over railway network that are able to efficiently manage any change to a timetable defining a routing plan for the guided vehicles.

This objective is achieved by the measures taken in accordance with the independent claims. Further advantageous embodiments are proposed by the dependent claims.

More precisely, the present invention concerns a method for managing traffic of guided vehicles over a railway network, the method including:
a) acquiring or receiving a timetable for the guided vehicles, the timetable containing departure and/or arrival times of the guided vehicles at reference positions of the railway network, and/or optionally one or several crossing times, wherein each crossing time defines a time at which a guided vehicle is crossing one of the reference positions (in other words, the arrival time and the departure time are identical and equal to the crossing time at the reference position), wherein the reference positions comprise for instance a position of a station and/or a position of a depot and/or any other relevant position on the railway network;
b) acquiring or receiving a map of the railway network;
c) using the map of the railway network for automatically dividing/splitting the railway network into a set of successive track sections, wherein each track section is delimited by at least two boundary positions, wherein at least one of the two boundary positions is a common boundary position with another track section of the set;
d) for each boundary position, automatically determining a list of the guided vehicles crossing the boundary position, wherein the list is configured for ordering the guided vehicles crossing the boundary position according to their temporal succession at the boundary position (e.g. the first guided vehicle in the list is the guided vehicle crossing first the boundary position, the second guided vehicle being the second one crossing the boundary position, etc. until the last guided vehicle of the list, or inversely, the first guided vehicle of the list being the last guided vehicle crossing the boundary position and the last guided vehicle being the first one crossing the boundary position). Important is that the list defines the successive temporal order of the listed guided vehicles at the boundary position;
e) automatically creating, from the map, the boundary positions and their associated list, a directed graph comprising nodes and directed edges, wherein each node represents an itinerary followed by one of the guided vehicles, the itinerary being defined as a series of successive and consecutive boundary positions that are crossed by the guided vehicle, and wherein each directed edge is configured for connecting two of the nodes with one another according to a direction leading from one of the two nodes, called “starting node”, to the other one of the two nodes, called “ending node”, wherein the directed edge is configured for representing an order relationship (predecessor/successor) between the guided vehicle of the starting node and the guided vehicle of the ending node, wherein if the guided vehicle of the starting node is different from the guided vehicle of the ending node, then the guided vehicle of the starting node precedes the guided vehicle of the ending node at each boundary position that they have in common in their respective itinerary as defined by their respective node, and wherein if the guided vehicle of the starting node is the same as the guided vehicle of the ending node, then the itinerary defined by the starting node precedes the itinerary defined by the ending node;
f) using the directed graph as input to an algorithm configured for automatically detecting whether the directed graph comprises one or several cycles (wherein a cycle is a closed path, i.e. a sequence of directed edges and nodes that starts from one of the nodes, called initial node, and ends at the initial node, wherein all directed edges are distinct and the only node occurring twice is the initial node, which occurs exactly twice); and
g) if no cycle is detected by the algorithm, then managing the traffic of the guided vehicles according to the timetable.

The present invention relates also to a traffic control system for managing traffic of guided vehicles over a railway network. The traffic control system contains a processor and a memory, the traffic control system being configured for managing traffic of the guided vehicles over the railway network according to a timetable as previously described. The timetable being received or acquired by the traffic control system and preferentially stored in the memory. The traffic control system being configured for:
a) acquiring a map of the railway network, and for using the map of the railway network for automatically dividing/splitting the railway network into a set of successive track sections, wherein each track section is delimited by at least two boundary positions, wherein at least one of the two boundary positions is a common boundary position with another track section of the set;
b) automatically determining, for each boundary position, a list of the guided vehicles crossing the boundary position, and, in each list, for ordering the guided vehicles according to their temporal succession at the boundary position;
c) automatically creating, from the map, the boundary positions and their associated list, a directed graph containing nodes and directed edges, wherein each node represents an itinerary followed by one of the guided vehicles, the itinerary being defined as a series of successive and consecutive boundary positions that are crossed by the guided vehicle, and wherein each directed edge is configured for connecting two of the nodes with one another according to a direction leading from one of the two nodes, called “starting node”, to the other one of the two nodes, called “ending node”, wherein the directed edge is configured for representing an order relationship (predecessor/successor) between the guided vehicle of the starting node and the guided vehicle of the ending node, wherein if the guided vehicle of the starting node is different from the guided vehicle of the ending node, then the guided vehicle of the starting node precedes the guided vehicle of the ending node at each boundary position that they have in common in their respective itinerary as defined by their respective node, and wherein if the guided vehicle of the starting node is the same as the guided vehicle of the ending node, then the itinerary defined by the starting node precedes the itinerary defined by the ending node;
d) using the directed graph as input to an algorithm configured for automatically detecting whether the directed graph comprises one or several cycles (wherein a cycle is a closed path, i.e. a sequence of directed edges and nodes that starts from one of the nodes, called initial node, and ends at the initial node, wherein all directed edges are distinct and the only node occurring twice is the initial node, which occurs exactly twice); and
e) if no cycle is detected by the algorithm, then managing the traffic of the guided vehicles according to the timetable.

The method and the system previously described enable the traffic control system to automatically and autonomously detect if a change in a timetable leads to inconsistencies in the routing and scheduling (or ordering) of the guided vehicles. Additionally, as explained afterwards, if an inconsistency is detected, it further enables to automatically correct the inconsistency, ensuring thus a continuous adaptation of the traffic of guided vehicles to timetable changes by taking appropriate actions.

According to the present invention, if at least one cycle is detected by the algorithm, then, for each detected cycle, the traffic control system is configured for automatically determining by means of the algorithm whether the direction of one or several directed edges involved in the cycle might be reversed for breaking the concerned cycle, and if yes, then reversing the direction of at least one among the one or several directed edges involved in the cycle; and
a) if each detected cycle has been broken by reversing at least one of its directed edges, then automatically generating by the algorithm a new timetable taking into account the reversed directed edge(s), and managing the traffic of the guided vehicles according to the new timetable; otherwise,
b) if at least one detected cycle has not been broken, then automatically generating an alert.

In other words, the traffic control system according to the invention is able to automatically correct inconsistencies appearing in a timetable and resulting from a change in the timetable. In particular, if several cycles are detected, then the traffic control system is configured for ordering the cycles according to an increasing number of guided vehicles involved in each cycle, and implementing an iteration for breaking cycles, wherein the iteration starts from the cycle which comprises the smallest number of guided vehicles and ends with the cycle comprising the largest number of guided vehicles, unless a cycle cannot be broken, in which case the iteration stops at the cycle which cannot be broken.

Preferentially, for determining whether the direction of one or several directed edges involved in a detected cycle might be reversed, the algorithm is configured for classifying the directed edges of the detected cycle in two groups, namely a first group containing directed edges that can be reversed and a second group containing directed edges that cannot be reversed. A directed edge of the detected cycle is classified by the algorithm into the second group if it is at least one of:
a) a directed edge whose direction has been previously reversed in response to a request for changing the temporal order of crossing/passing vehicles in one of the lists associated to one of the boundary positions;
b) a directed edge which is not connected to a node to which a previously reversed directed edge is connected;
c) a directed edge whose reversing would reverse a previous order of successive itineraries for a guided vehicle; or
d) a directed edge which is assigned a fixed direction.

Otherwise, it is classified into the first group, the algorithm being further configured for automatically reversing one or several of the directed edges of the first group for breaking the detected cycle. If the first group contains a single directed edge, then the algorithm automatically reverses the directed edge. In such a case, there is a single solution for breaking the cycle. If the first group contains several directed edges, then the algorithm is configured for automatically applying a reversing rule configured for optimizing the traffic, i.e. the flow of guided vehicles. The reversing rule is for instance one of, or a combination of the following rules or actions that are implemented by the traffic control system via its algorithm when breaking cycles:
minimizing the number of reversed directed edges for breaking the cycle, notably when breaking all cycles;
reversing a set of directed edges that minimizes time differences between the new timetable and the received or acquired timetable;
reversing one or several directed edges that minimize a delay time of guided vehicles comprising a high passenger occupancy;
reversing one or several directed edges that minimize a delay time of a priority guided vehicle.

Of course, other rules or actions might be defined for optimizing the traffic when an inconsistency is detected in a timetable. The traffic control system is typically configured for automatically determining which directed edge(s) within the first group has or have to be reversed for satisfying the rule, e.g. for minimizing the number of reversed directed edges.

Preferentially, the traffic control system is further configured for automatically creating a sequencing graph from the map, the timetable, the boundary positions and their associated list. The sequencing graph contains nodes and edges, wherein each node represents one of the boundary positions and is assigned the list of guided vehicles passing/crossing the boundary position, wherein each edge is configured for connecting two boundary positions and represents one of the track sections delimited by (or connecting) the two boundary positions according to the map, each edge being assigned the moving direction configured for indicating the direction of travel followed by the guided vehicle(s) of the list according to the timetable when moving on the track section from one of the boundary positions to the other one. In particular, the directed graph might be automatically generated from the sequencing graph by the traffic control system. The sequencing graph might be further displayed, e.g. on a screen, providing a simple representation of the ordering of guided vehicles at each boundary position, and enabling for instance an interaction of an operator with the sequencing graph for reordering guided vehicles at one of the boundary positions.

In particular, the timetable received or acquired by the traffic control system may comprise a change requested by an operator. The change is for instance a modification of an arrival time and/or a modification of a departure time and/or a modification of a crossing time at one or several reference points, and/or a modification of a temporal order of guided vehicles in a list associated to a boundary position. Typically, the change might be applied by an operator to an already existing timetable whose corresponding directed graph was free of any cycle, and which, after incorporation of the change, results in a modified timetable that has to be checked, by the traffic control system according to the invention, for coherence with respect to the departure, arrival, and optionally crossing times defined by it for the guided vehicles.

Preferentially, the traffic control system according to the invention uses a splitting algorithm for automatically splitting the railway network into the set of successive track sections, wherein the splitting algorithm is configured for applying splitting rules for automatically positioning the boundary positions on the railway network. In particular, the splitting algorithm may use the following splitting rules:
a) creating a boundary position between two directly successive switches, each of the switches being converging in direction of the boundary position;
b) creating a boundary position at the crossing of two tracks, wherein two tracks arrive at the boundary position and two tracks depart from the boundary position;
c) creating a boundary position between a switch and a stop signal and/or creating a boundary position at the stop signal;
d) creating a boundary position downstream a converging switch (i.e. after the switch, on the converging path towards which any of the diverging paths converge, wherein the switch is considered as dividing one track (the converging path) into two (the diverging paths)); and
e) optionally, creating a boundary position per platform.

Other features which are considered as characteristic for the invention are set forth in the appended claims.

Although the invention is illustrated and described herein as embodied in a method and a system for managing traffic of guided vehicles over a railway network, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

Further aspects of the present invention will be better understood through the following drawings, wherein like numbers designate like objects.

FIG. 1 is a schematic illustration of a railway network according to the invention;

FIG. 2 is a flowchart of a preferred embodiment of a method according to the invention;

FIG. 3 is a schematic illustration of a sequencing graph according to the invention;

FIG. 4 is a schematic illustration of a directed graph according to the invention;

FIG. 5A is a schematic illustration of another sequencing graph containing a guiding vehicle ordering inconsistency;

FIG. 5B is a schematic illustration of a directed graph corresponding to the sequencing graph of FIG. 5A and that contains a cycle;

FIG. 6A is a schematic illustration of a reordering of guided vehicles in a sequencing graph according to the invention;

FIG. 6B is schematic illustration of a directed graph corresponding to FIG. 6A;

FIG. 7A is a schematic illustration of a sequencing graph resulting from the reordering illustrated in FIG. 6A;

FIG. 7B is a schematic illustration of a directed graph corresponding to the sequencing graph of FIG. 7A;

FIG. 8 is a schematic illustration of a correction of the new sequencing graph;

FIG. 9 is a schematic illustration of a directed graph representing the corrected new sequencing graph; and

FIG. 10 is a schematic illustration of a traffic control system according to the invention.

### DETAILED DESCRIPTION OF THE INVENTION

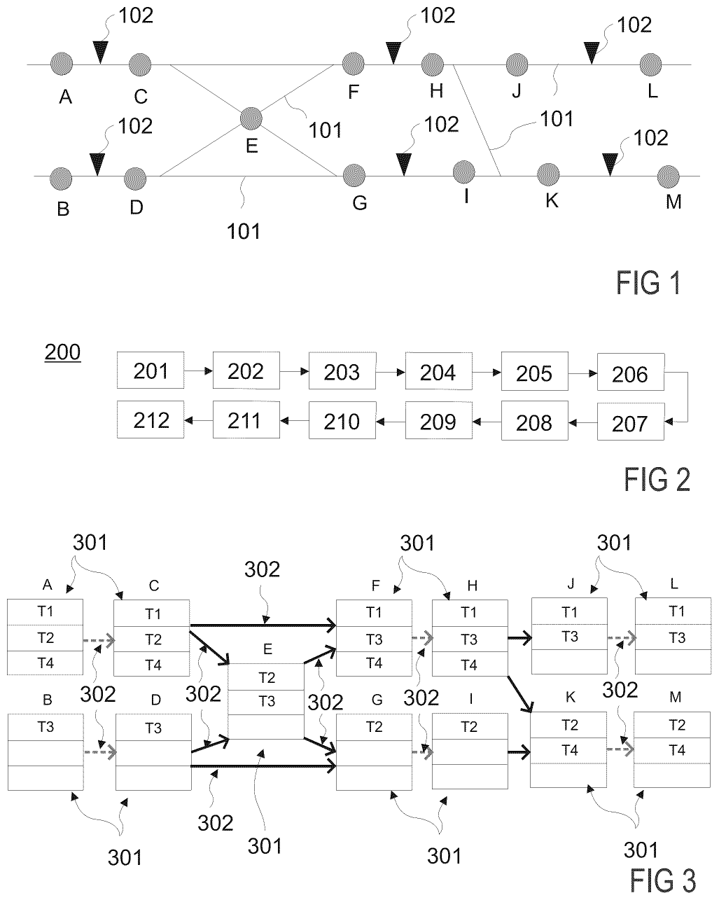

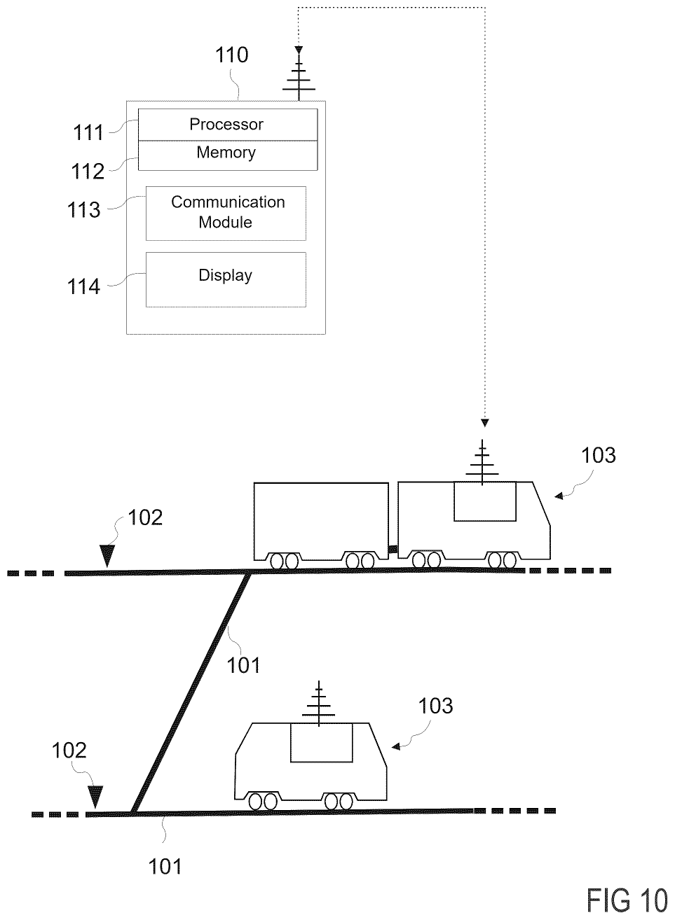

Referring now to the figures of the drawings in detail and first, particularly to FIG. 1 thereof, there is shown a schematic illustration of a railway network 100. The latter comprises tracks 101 interconnected with each other to form a network. The railway network 100 further comprises various railway signaling systems installed along the tracks 101, and notably stop signals 102, wherein guided vehicles, e.g. trains 103 (see FIG. 10), may have to stop. Different reference positions might be defined in the railway network, like the position of a station, or the position of a depot, the position of a level crossing, the position of a stop signal, or any other visible point of interest to which a schedule could be applied. The traffic control system 110 according to the invention is better illustrated in FIG. 10. It comprises at least a processor 111 and a memory 112. The traffic control system 110 is configured for managing traffic on the railway network 100 according to a received or acquired timetable. For this purpose, it may comprise a communication module 113 for communicating with the guided vehicles 103 and/or with railway signaling systems, like the signals 102, notably for sending a control order configured for controlling for instance the railway signaling system. Usually, radio communication 115 is preferred. In case of a change in a received timetable resulting in a changed timetable, the traffic control system 110 according to the invention is able to automatically check whether the schedules of each guided vehicle and as defined by the changed timetable are consistent with each other before using the changed timetable for managing the traffic of the guided vehicles on the railway network according to the changed timetable, and if an inconsistency is found, then it is able to automatically correct the changed timetable for removing the inconsistency, or to automatically alert an operator if the inconsistency cannot be removed.

This will be better understood with the help of FIG. 2 which shows a preferred embodiment of a method 200 according to the invention.

At step 201, the traffic control system 110 receives or acquires a timetable for the guided vehicles. The timetable might be a completely new timetable, or a previous timetable containing a change. Typically, for each guided vehicle crossing or reaching one of the reference position, the timetable associates to the reference position either the crossing time at which the guided vehicle (e.g. the front of the guided vehicle) crosses the reference position, or an arrival time and a departure time indicating the time at which the guided vehicle (e.g. its front) reaches the reference position, and the time at which it leaves (e.g. its front) the reference position.

At step 202, which can take place before, after, or simultaneously to step 201, the traffic control system 110 acquires or receives a map of the railway network. The map enables the traffic control system 110 to determine the position of the different tracks, reference positions, etc., and thus to determine the different routes that the guided vehicles can follow.

At step 203, the traffic control system 110 automatically divides or split the railway network into a set of successive track sections. Such a splitting/division is shown in FIG. 1, wherein the dots A-M represent each a boundary position between two of the track sections. For instance, the segment of track [A, C] is a first track section, and the segment of track [C,E] is a second track section, the boundary position C being the common boundary position to the first and second track sections. For this purpose, and as explained earlier, the traffic control system 110 may use a splitting algorithm that will automatically split the railway network into successive track sections delimited by boundary positions, by automatically determining, from splitting rules, where, on the railway network, a boundary position shall be located. Steps 202 and 203 are preferentially performed before step 201, the traffic control system 110 storing for instance in a database the location of each boundary position on the railway network.

At step 204, the traffic control system 110 automatically determines, for each boundary position A-M, and notably from the timetable and the position of each boundary position on the railway network, a list of the guided vehicles that cross the boundary position. Such lists are shown in the sequencing graph of FIG. 3. For instance, for the boundary position A, the guided vehicle T1 crosses the boundary position A before the guided vehicle T2, which crosses the boundary position A before the guided vehicle T4. The list temporally orders the guided vehicles crossing the considered boundary position, from the first to the last guided vehicle crossing the boundary position.

At step 205, and optionally, the traffic control system 110 creates a sequencing graph as illustrated in FIG. 3. The sequencing graph contains nodes 301 and edges 302. Each node 301 represents one of the boundary positions A-M. For simplicity, the node corresponding to a boundary position “i” will be called hereafter the “node i”. To each node 301 is further assigned or associated the list of guided vehicles passing/crossing the boundary position. Each edge 302 connects two nodes, and thus two boundary positions. One node 301 might be connected to several other nodes via the edges 302. For instance, the node C is connected to the node E and to the node F. Each edge 302 is represented by an arrow whose direction represents the moving direction for a guided vehicle of the list from a starting node to an arrival node. It defines thus a moving direction for the considered guided vehicle. For instance, when considering the node C, the guided vehicle T1 will move from the node C towards the node F, while the guided vehicle T2 will move from the node C to the node E. Preferentially, the sequencing graph contains two types of edges 302, namely “pass-through edges with possible stop” (shown with dotted arrow) and “pass-through edge without possible stop” (shown with continuous line arrow), wherein pass-through edges with possible stop indicate a presence of a planned stopping position (i.e. the presence of a stop signal 102) for a guided vehicle between the boundary positions connected by the edge, and wherein a pass-through edge without possible stop indicates an absence of such planned stopping position between the boundary positions connected by the edge. At the planned stopping position, a guided vehicle can be at stand still for letting another guided vehicle reaching a next boundary position before it. This enables the traffic control system 110 to automatically determine which track sections can be used for letting a second guided vehicle pass before a first guided vehicle by maintaining the latter at stand still at a stop signal 102. Preferentially, the sequencing graph is displayed on a display 114 of the traffic control system 110. The sequencing graph provides, to an operator, an intelligible view of the sequencing of the guided vehicles at each boundary position. It also enables the operator to easily change the order of guided vehicles at a specific boundary position by interacting with the sequencing graph.

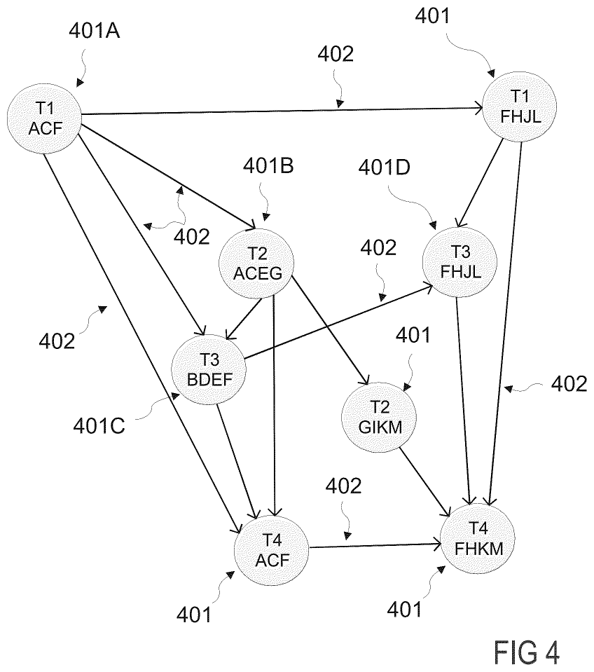

At step 206, either from the sequencing graph, or directly from the map, the boundary positions, and their associated list, the traffic control system 110 automatically generates a directed graph. Such directed graph is illustrated in FIG. 4 for the timetable defined by the sequencing graph of FIG. 3. The directed graph contains nodes 401, 401A-D and directed edges 402 represented by arrows. Each node 401 represents an itinerary followed by one of the guided vehicles 103. For instance, the node 401A defines for the guided vehicle T1 an itinerary passing successively through the boundary positions A, C, and F. The itinerary defines thus a series of temporally successive and consecutive boundary positions crossed by the guided vehicle. It typically starts with a first boundary position located upstream (with respect to the direction of travel of the guided vehicle) a reference position (called hereafter the “stopping reference position”) wherein the guided vehicle is authorized to stop or might stop for letting for instance another guided vehicle to overtake the guided vehicle, the stopping reference position being preferentially the first reference position that the guided vehicle will cross when moving from the first boundary position in direction of the stopping reference position, the stopping reference position being typically a stop signal, the itinerary ending upstream another stopping reference position wherein the guided vehicle is authorized to stop or may stop. For instance, an itinerary might thus correspond to the series of successive and consecutive boundary positions crossed by the guided vehicle between a first stop signal and a second stop signal when moving from the first stop signal towards the second stop signal, the series further containing as first boundary position of the series, the boundary position located upstream the first stop signal and that is the last boundary position crossed by the guided vehicle when moving towards the first stop signal. As shown in FIG. 4, each directed edge 402 connects two nodes 401, and each node 401 might be connected, via one or respectively several of the directed edges to one or respectively several other nodes 401. To each edge 402 is associated a direction that is represented by the orientation or direction of the arrow. Each edge 402 connects thus a starting node (at the basis of the arrow) to an ending node (at the tip of the arrow). The direction defined by the directed edge, i.e. by the arrow, represents an order relationship (predecessor/successor) between the guided vehicle of the starting node and the guided vehicle of the ending node. For instance, if one considers the nodes 401A and 401B of FIG. 4, the guided vehicle T1 precedes the guided vehicle T2 in the boundary positions they have in common in their respective itinerary, that is, guided vehicle T1 precedes the guided vehicle T2 in the boundary position A and C. If nodes connected by a directed edge 402 are assigned to a same guided vehicle, like the nodes 401C and 401D which are both assigned to the guided vehicle T3, then the itinerary defined by the starting node, i.e. the itinerary passing successively through the boundary positions B, D, E, and F according to node 401C precedes the itinerary defined by the ending node, i.e. after having crossed the boundary position F, the guided vehicle T3 will then successively cross the boundary positions F, H, J, and L associated to node 401D.

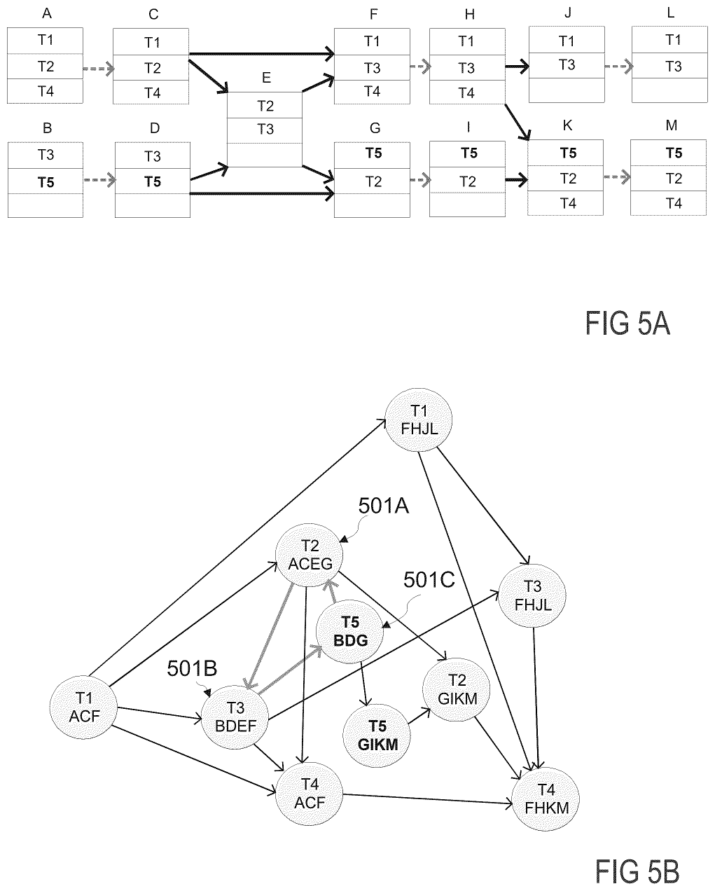

At step 207, the traffic control system 110 uses the directed graph as input to an algorithm configured for automatically detecting whether the directed graph contains one or several cycles. Such a cycle is illustrated in FIG. 5B and contains nodes 501A, 501B, and 501C. It forms a cycle because the node 501A is connected by a first directed edge to the node 501B, which is connected by a second directed edge to the node 501C, which is itself connected by a third directed edge back to the node 501A, closing the cycle or loop. When following the direction defined by the arrows representing the directed edges, and thus the precedence relationship between the guided vehicles at different boundary positions as defined by their respective itinerary, one can observe that when starting at a starting node (e.g. node 501A), the precedence relationship defined by the arrows leads at the end to the starting node, defining therefore a cycle that starts and ends at the same node. The algorithm for detecting a cycle in a directed graph might be based on graph theory, notably as disclosed in D. B. Johnson (SIAM J. Comput., Vol. 4, N°1, March 1975, “Finding all the Elementary Circuits of a Directed Graph”) or R. Tarjan (SIAM J. Comput., Vol. 1, N° 2, June 1972, “Depth-First Search and Linear Graph Algorithm”) studies.

At step 208, if no cycle is detected by the algorithm, then the traffic control system 110 uses the received or acquired timetable of step 201 for managing the traffic of the guided vehicles on the railway network. Indeed, if no cycle is detected, the traffic control system 110 considers then the timetable as consistent, having checked that there is no conflict between the schedules of the different guided vehicles. It can then safely apply the timetable for managing the traffic of guided vehicles.

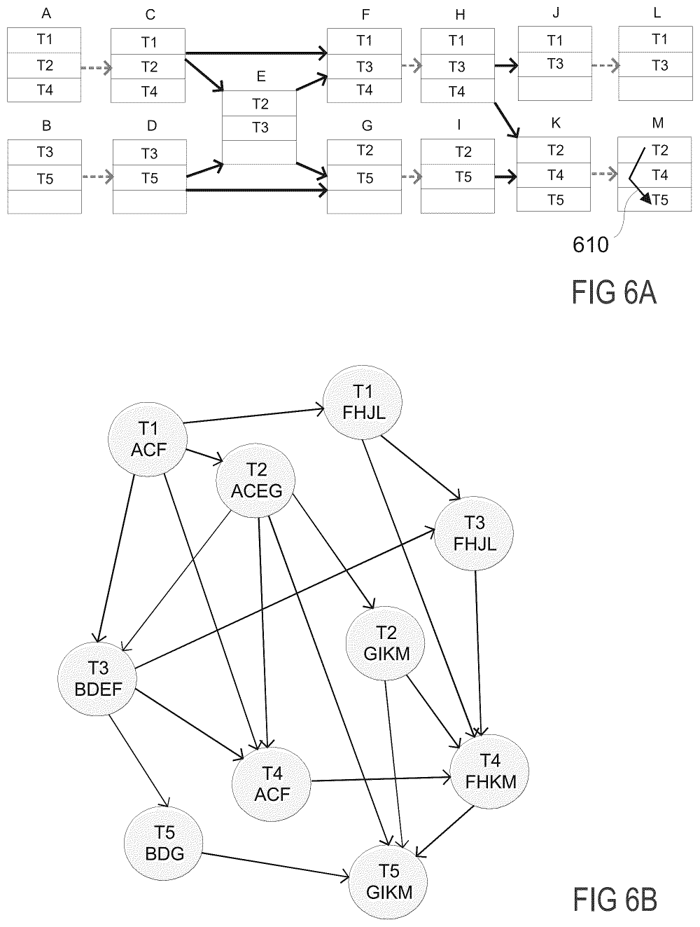

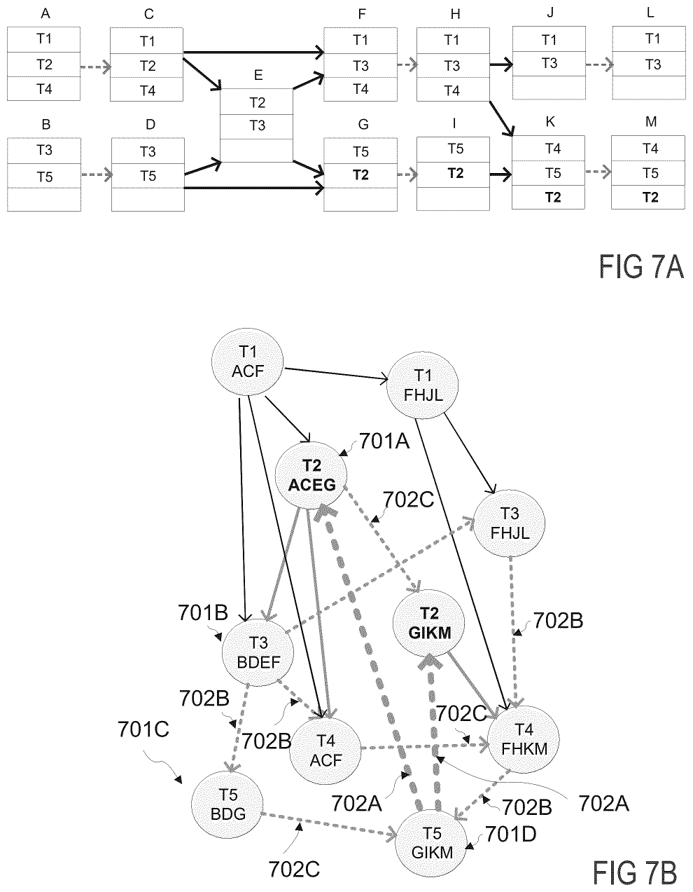

However, if at least one cycle is detected at step 209, then, for each detected cycle, the traffic control system 110 automatically determines, by means of the algorithm, whether the direction of one or several directed edges involved in the detected cycle might be reversed for breaking the concerned cycle. For instance, the timetable corresponding to the sequencing graph described in FIG. 3 might be amended for incorporating an additional route or itinerary defined for a guided vehicle T5 and leading to a new timetable that corresponds to the sequencing graph shown in FIG. 5A. For this new timetable, the traffic control system 110 detects, by implementing the steps described above, a cycle comprising nodes 501A, 501B, and 501C as illustrated in the corresponding directed graph of FIG. 5B. This means that some schedules of the guided vehicles are not coherent with each other. According to another example, an operator may reorder the guided vehicles at a boundary position. This is illustrated by FIGS. 6A, 6B, 7A, and 7B. FIGS. 6A and 6B are respectively the sequencing graph and the directed graph of a timetable for which no cycles have been detected (see FIG. 6B). The operator may then request that the guided vehicle T2 be after the guided vehicle T5 at boundary position M as illustrated by the arrow 610 in FIG. 6A. The reordering results in a new sequencing graph presented in FIG. 7A and a corresponding new directed graph presented in FIG. 7B. As can be seen from FIG. 7B in comparison with FIG. 6B, this reordering also created a cycle comprising the nodes 701A, 701B, 701C, and 701D. For each amendment or modification of the timetable, coming from an operator, or from any other event, like a delay occurring on the railway network, the traffic control system 110 will automatically check whether the directed graph corresponding to the (modified) timetable received as input comprises or not one or several cycles. For each detected cycle, the traffic control system 110 determines which directed edges cannot be reversed, creating therefore a first group of directed edges which will comprise directed edges that can be reversed, and a second group of directed edges comprising directed edges that cannot be reversed. Predefined rules are used by the traffic control system 110 for determining whether a directed edge can be reversed or not. This is schematically illustrated in FIG. 7B:
directed edges 702A represent directed edges that have been reversed in response to the reordering requested by the operator, and such directed edges cannot be reversed again, and belong to the second group;
directed edges 702B represent directed edges that are not connected to a node for a guided vehicle for which a reordering took place, i.e. to which a previously reversed directed edge is connected. Such directed edges 702B cannot be reversed and belong to the second group;
directed edges 702C represent directed edges whose reversing would reverse a previous order of successive itineraries for a guided vehicle. Such directed edges cannot be reversed and belong to the second group; and
a directed edge which is assigned a fixed direction cannot be reversed and belongs to the second group.

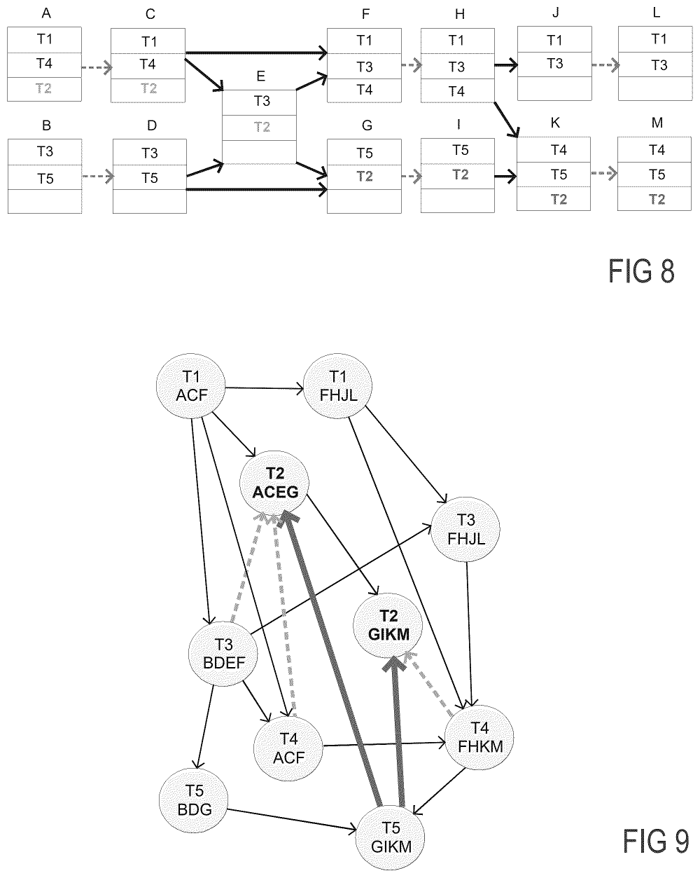

Then, at step 210, the algorithm reverses, for instance iteratively reverses, the directed edges of the first group. For this purpose, the algorithm preferentially applies reversing rules configured for optimizing the new timetable with respect to the received timetable. The algorithm automatically stops as soon as all cycles have been broken. FIGS. 8 and 9 present the result obtained after reversing some of the directed edges of the directed graph of FIG. 7A. The reversed directed edges are represented in the directed graph of FIG. 9 by dotted lines, and the corresponding sequencing graph is illustrated in FIG. 8.

At step 211, if each detected cycle has been broken by reversing at least one of its directed edges, then the traffic control system 110 automatically generates by means of the algorithm a new timetable, wherein the new timetable incorporates modifications corresponding to the reversed directed edges.

Finally, at step 212, the traffic control system 110 uses the new timetable for controlling or managing the traffic of the guided vehicles on the railway network. However, if the traffic control system 110 was not able to break one of the detected cycles, then it automatically generates an alert, preventing therefore to implement the timetable received or acquired at step 201.

To conclude, the present invention proposes a new traffic control system and method for managing traffic of guided vehicles that enable to automatically check whether a modification in a timetable may create inconsistencies in the schedules of guided vehicles as defined by the modified timetable, and to automatically correct the inconsistencies or to alert, for instance an operator, if at least one inconsistency cannot be corrected. This highly improves guided vehicle traffic flow on a railway network.

1. A method for managing traffic of guided vehicles over a railway network, which comprises the steps of:
acquiring a timetable for the guided vehicles, the timetable containing departure and/or arrival times of the guided vehicles at reference positions of the railway network;
acquiring a map of the railway network;
using the map of the railway network for automatically splitting the railway network into a set of successive track sections, wherein each of the track sections is delimited by at least two boundary positions, wherein at least one of the two boundary positions is a common boundary position with another track section of the set of successive track sections;
automatically determining a list of the guided vehicles crossing a boundary position for each of the boundary positions, wherein the list is configured for ordering the guided vehicles according to their temporal succession at the boundary position;
automatically creating, from the map, the boundary positions and the list associated therewith, a directed graph containing nodes and directed edges, wherein each node of the nodes represents an itinerary followed by one of the guided vehicles, the itinerary being defined as a series of successive and consecutive said boundary positions that are crossed by the guided vehicle, and wherein each of the directed edges is configured for connecting two of the nodes with one another according to a direction leading from one of the two nodes, called a “starting node”, to the other one of the two nodes, called an “ending node”, wherein a directed edge of the directed edges is configured for representing an ordered relationship between a guided vehicle of the starting node and the guided vehicle of the ending node, wherein if the guided vehicle of the starting node is different from the guided vehicle of the ending node, then the guided vehicle of the starting node precedes the guided vehicle of the ending node at each boundary position that they have in common in their respective said itinerary as defined by their respective said node, and wherein if the guided vehicle of the starting node is a same as the guided vehicle of the ending node, then the itinerary defined by the starting node precedes the itinerary defined by the ending node;
using the directed graph as input to an algorithm configured for automatically detecting whether the directed graph contains one or several cycles; and
if no cycle is detected by the algorithm, then managing the traffic of the guided vehicles according to the timetable.

2. The method according to claim 1, wherein:
if at least one said cycle is detected, then, for each detected said cycle, automatically determining by the algorithm whether the direction of one or several said directed edges involved in the cycle might be reversed for breaking a concerned cycle, and if yes, then reversing at least one of the directed edges involved in the cycle; and
if each detected said cycle has been broken by reversing at least one of its said directed edges, then automatically generating by the algorithm a new timetable taking into account at least one reversed directed edge, and managing the traffic of the guided vehicles according to the new timetable; otherwise,
if at least one detected said cycle has not been broken, then automatically generating an alert.

3. The method according to claim 2, wherein, if several said cycles are detected, then ordering the cycles according to an increasing number of the guided vehicles involved in each said cycle, and implementing an iteration for breaking the cycles that start from the cycle which contains a smallest number of the guided vehicles and ends with the cycle containing a largest number of the guided vehicles, unless the cycle cannot be broken, in which case the iteration stops at the cycle which cannot be broken.

4. The method according to claim 2, wherein for determining whether the direction of one or several said directed edges involved in the detected cycle that might be reversed, classifying, by the algorithm, the directed edges of the detected cycle in two groups, namely a first group containing the directed edges that can be reversed and a second group containing the directed edges that cannot be reversed, wherein the directed edge of the detected cycle belongs to the second group if it is at least one of:
the directed edge whose direction has been previously reversed in response to a request for changing a temporal order of crossing/passing the guided vehicles in one of a plurality of lists associated to one of the boundary positions that cannot be reversed;
the directed edge which is not connected to a node to which a previously reversed directed edge is connected cannot be reversed;
the directed edge whose reversing would reverse a previous order of successive itineraries for the guided vehicle that cannot be reversed;
a directed edge which is assigned a fixed direction; and
otherwise the directed edge belongs to the first group, the method further comprising automatically reversing one or several of the directed edges of the first group for breaking the detected cycle.

5. The method according to claim 4, wherein, for reversing the one or several said directed edges of the first group, the algorithm is configured for applying a reversing rule configured for optimizing the traffic.

6. The method according to claim 1, which further comprises:
automatically creating a sequencing graph from the map, the timetable, the boundary positions and associated said list, wherein the sequencing graph contains said nodes and said directed edges, wherein each said node represents one of the boundary positions and is assigned to the list of the guided vehicles passing/crossing the boundary position, wherein each said directed edge is configured for connecting two said nodes and represents one of the track sections delimited by the two boundary positions represented by the connected two said nodes according to the map, each said directed edge being assigned a moving direction configured for indicating the direction of travel followed by the guided vehicle of the list according to the timetable when moving on the track section from one of the boundary positions to the other one, and automatically generating the directed graph from the sequencing graph.

7. The method according to claim 1, wherein the timetable contains a change requested by an operator, wherein the change is a modification of the arrival time and/or a modification of the departure time and/or a modification of a crossing time at one or several reference points, and/or a modification of a temporal order of the guided vehicles in the list associated to the boundary position.

8. The method according to claim 1, which further comprises using a splitting algorithm for automatically splitting the railway network into the set of successive track sections, wherein the splitting algorithm is configured for applying splitting rules for automatically positioning the boundary positions on the railway network, wherein the splitting rules comprise:
creating the boundary position between two directly successive switches, wherein each of the switches are converging in the direction of the boundary position;
creating the boundary position at the crossing of two tracks, wherein two tracks arrive at the boundary position and two said tracks depart from the boundary position;
creating the boundary position between a switch and a stop signal and/or creating the boundary position at the stop signal; and
creating the boundary position downstream of a converging switch.

9. A traffic control system for managing traffic of guided vehicles over a railway network, the traffic control system comprising:
a processor having a memory, the traffic control system being configured for managing the traffic of the guided vehicles over the railway network according to a timetable, the traffic control system being configured for:
acquiring or receiving the timetable, wherein the timetable contains departure and/or arrival times of the guided vehicles at reference positions of the railway network;
acquiring a map of the railway network, and for using the map of the railway network for automatically dividing/splitting the railway network into a set of successive track sections, wherein each of the track sections is delimited by at least two boundary positions, wherein at least one of said at least two boundary positions is a common boundary position with another track section of the set of successive track sections;
automatically determining, for each boundary position, a list of the guided vehicles crossing the boundary position, and, in each said list, for temporally ordering successive said guided vehicles crossing the boundary position;
automatically creating, from the map, the boundary positions and the list, a directed graph containing nodes and directed edges, wherein each node of the nodes represents an itinerary followed by one of the guided vehicles, the itinerary being defined as a series of successive and consecutive said boundary positions that are crossed by a guided vehicle, and wherein each directed edge is configured for connecting two of the nodes with one another according to a direction leading from one of the two nodes, called a “starting node”, to another one of the two nodes, called an “ending node”, wherein the directed edge is configured for representing an order relationship between the guided vehicle of the starting node and the guided vehicle of the ending node, wherein if the guided vehicle of the starting node is different from the guided vehicle of the ending node, then the guided vehicle of the starting node precedes the guided vehicle of the ending node at each said boundary position that they have in common in their respective said itinerary as defined by their respective said node, and wherein if the guided vehicle of the starting node is a same as the guided vehicle of the ending node, then the itinerary defined by the starting node precedes the itinerary defined by the ending node;
using the directed graph as input to an algorithm configured for automatically detecting whether the directed graph comprises one or several cycles; and
if no cycle is detected by the algorithm, then managing the traffic of the guided vehicles according to the timetable.

10. The traffic control system according to claim 9, wherein, if at least one said cycle is detected, then, for each detected said cycle, the traffic control system is configured for automatically determining by means of the algorithm whether the direction of one or several said directed edges involved in the cycle might be reversed for breaking a concerned cycle, and if yes, then reversing the direction of at least one concerned directed edge; and
if each detected said cycle has been broken by reversing at least one of its said directed edges, then automatically generating by the algorithm a new timetable taking into account reversed directed edges, and managing the traffic of the guided vehicles according to the new timetable; otherwise,
if at least one detected said cycle has not been broken, then automatically generating an alert.

11. The traffic control system according to claim 10, wherein, if several said cycles are detected, then the traffic control system is configured for ordering the cycles according to an increasing number of the guided vehicles involved in each said cycle, and implementing an iteration for breaking the cycles that start from the cycle which contains a smallest number of said guided vehicles and ends with the cycle containing a largest number of the guided vehicles, unless the cycle cannot be broken, in which case the iteration stops at the cycle which cannot be broken.

12. The traffic control system according to claim 10, wherein, for determining whether the direction of one or several said directed edges involved in a detected said cycle might be reversed, the algorithm is configured for classifying the directed edges of the detected cycle in two groups, namely a first group containing the directed edges that can be reversed and a second group containing the directed edges that cannot be reversed, wherein the directed edge of the detected cycle belongs to the second group if it is at least one of:
the directed edge whose direction has been previously reversed in response to a request for changing a temporal order of crossing/passing the guided vehicles in one of a plurality of lists associated to one of the boundary positions cannot be reversed;
the directed edge which is not connected to a node to which a previously reversed directed edge is connected cannot be reversed;
the directed edge whose reversing would reverse a previous order of successive itineraries for the guided vehicle cannot be reversed;
the directed edge which is assigned a fixed direction; and
otherwise the directed edge belongs to the first group, the algorithm being configured for automatically reversing one or several of the directed edges of the first group for breaking the detected cycle.

13. The traffic control system according to claim 9, the traffic control system is configured for automatically creating a sequencing graph from the map, the timetable, the boundary positions and associated said list, wherein the sequencing graph contains the nodes and the directed edges, wherein each said node represents one of the boundary positions and is assigned the list of the guided vehicles passing/crossing the boundary position, wherein each said directed edge is configured for connecting two said nodes and represents one of the track sections delimited by two boundary positions represented each by a different one of the two nodes, each said directed edge being assigned a moving direction configured for indicating the direction of travel followed by the guided vehicle of the list according to the timetable when moving on the track section from one of the boundary positions to the other one, and wherein the traffic control system is configured for automatically generating the directed graph from the sequencing graph.

14. The traffic control system according to claim 9, wherein the timetable contains a change requested by an operator, the change containing a modification of the arrival time and/or a modification of the departure time and/or a modification of a crossing time at one or several reference points, and/or a modification of a temporal order of the guided vehicles in the list associated to the boundary position.

15. The traffic control system according to claim 9, wherein the traffic control system is configured for using a splitting algorithm for automatically splitting the railway network into the set of successive track sections, wherein the splitting algorithm is configured for applying splitting rules for automatically positioning the boundary positions on the railway network, wherein the splitting rules comprise:
creating the boundary position between two directly successive switches, each of the switches converging in direction of the boundary position;
creating the boundary position at the crossing of two tracks, wherein two said tracks arrive at the boundary position and two said tracks depart from the boundary position;
creating the boundary position between a switch and a stop signal and/or creating the boundary position at the stop signal; and
creating the boundary position downstream of a converging switch.
